(19) United States
(12) Patent Application Publication
(10) Pub. No.: US 2025/0382075 A1
(43) Pub. Date: Dec. 18, 2025

(54) UAV PAYLOAD DEVICE MOUNTING ASSEMBLY WITH SHOCK ABSORPTION STRUCTURE

(71) Applicant: Xiamen Mugin Tech. Ltd., XIAMEN (CN)

(72) Inventors: XINFENG YU, XIAMEN (CN); JINJIAN MAO, XIAMEN (CN); YIBIN XU, XIAMEN (CN)

(73) Assignee: Xiamen Mugin Tech. Ltd., XIAMEN (CN)

(21) Appl. No.: 19/240,005

(22) Filed: Jun. 17, 2025

(30) Foreign Application Priority Data
Jun. 17, 2024 (CN) 202410774317.4

(51) Int. Cl. B64U 20/87; F16M 11/12; F16M 11/18

(52) U.S. Cl. CPC B64U 20/87; F16M 11/123; F16M 11/18

(57) ABSTRACT

An UAV payload device mounting assembly with a shock absorption structure includes a main body and wings connected to the main body; a side plate and a connection member disposed at an edge of an inner side of the side plate; a mounting component, composed of a shock absorption assembly and a butting assembly, for installation of a gimbal inside the main body; the shock absorption assembly includes an annular upper support plate, a lower support plate, and a damping member. A periphery of the annular upper support plate laterally protruding outward to form a plurality of arc-shaped bosses. The arc-shaped bosses are symmetrically arranged in pairs, and each arc-shaped boss is provided with a plurality of first through holes. The lower support plate is provided with recesses corresponding to the arc-shaped bosses. The mounting assembly offers better integration, simpler subsequent maintenance, and easier disassembly/assembly.

### TECHNICAL FIELD

The present disclosure relates to a Unmanned Aerial Vehicle (UAV) payload device mounting assembly with a shock absorption structure.

### BACKGROUND

UAV, fully known as Unmanned Aerial Vehicles, are aircraft capable of flight without an onboard human pilot. UAVs can be controlled by remote control or autonomous flight systems. They have extensive applications in military, commercial, and personal use. Common uses include aerial photography, agricultural monitoring, and security surveillance, etc.

However, the inventors have discovered that existing UAVs use relatively crude mounting structures for installing camera gimbals. During UAV flight, vibrations can cause the gimbal to shake. This may lead to the UAV losing balance due to a change in the center of gravity, severely affecting flight performance. Furthermore, as the gimbal shakes, power cables connected to it may loosen, impacting the gimbal's operation and the overall effectiveness of the UAV. Therefore, designing a payload mounting assembly that integrates shock absorption, reduces wiring, prevents cable loosening, and improves overall UAV balance is the research direction of the present disclosure.

### SUMMARY

The present disclosure provides a UAV payload device mounting assembly with a shock absorption structure, which can effectively solve the above problems.

The present disclosure is implemented as follows.

An Unmanned Aerial Vehicle (UAV) payload device mounting assembly with a shock absorption structure, comprising:
a main body and wings connected to the main body;
a side plate and a connection member disposed at an edge of an inner side of the side plate;
a mounting component, composed of a shock absorption assembly and a butting assembly, for mounting a gimbal inside the main body;
wherein the shock absorption assembly comprises: an annular upper support plate, a lower support plate, and damping members; the annular upper support plate has a periphery laterally protruding outward to form a plurality of arc-shaped bosses, the arc-shaped bosses being symmetrically arranged in pairs, and each arc-shaped boss is provided with a plurality of first through holes; the lower support plate is provided with recesses corresponding to the arc-shaped bosses, the recesses are each provided with second through holes corresponding to the plurality of first through holes; the damping members are connected between the first through holes and the second through holes.

As a further improvement, the connection member comprises a bracket, the bracket is provided at an end with an engagement protrusion, and a front end surface of the bracket forms an inclined portion for sliding contact with an insertion portion.

As a further improvement, the inclined portion has an angle D, wherein the angle D is greater than or equal to 30 degrees or less than or equal to 45 degrees.

As a further improvement, each damping member is provided at an end with a mating rod, the mating rods are configured for quick positioning and installation with the second through holes provided inside the recesses.

As a further improvement, each of the recesses has a depth C, wherein the depth C is greater than or equal to 5 mm or less than or equal to 7 mm.

As a further improvement, the butting assembly comprises: a locking plate; a connecting rod disposed at a middle portion of the locking plate; a locking spring disposed on an outer wall of the connecting rod; a push-pull member disposed on the outer wall of the connecting rod at a position forward of the locking spring; the insertion portion disposed at a front end of the push-pull member; and a limiting member disposed at a second end of the connecting rod; wherein pushing the push-pull member compresses the locking spring, the insertion portion connects with the connection member, and the locking spring rebounds, fixing the mounting component on the side plate.

As a further improvement, a bottom of the locking plate, between two connecting rods, is provided with an electrical component, the electrical component plugs into a power interface on the bracket to control power on/off to the gimbal; and two locking plates are assembled with a side above the electrical component being provided with a protective plate.

As a further improvement, the arc-shaped bosses are arranged circumferentially around the annular upper support plate with equal space apart from each other.

As a further improvement, a top surface of the annular upper support plate is symmetrically provided with engaging grooves for engaging with and clamping a camera.

As a further improvement, a material of the annular upper support plate is carbon fiber, and a material of the lower support plate is aluminum alloy.

The present disclosure has the following advantages. The present disclosure combines the electrical connection structure and the shock absorption structure. When installing the camera, the electrical connection mechanism facilitates easier power on/off for the camera. Simply using the two push-pull members can disconnect the electrical connection structure from the power socket. Furthermore, the added shock absorption structure provides a stable environment for the operation of the camera. Additionally, this disclosure features a more centralized design for the mounting component (gimbal), camera, and power source, resulting in better integration and simpler subsequent maintenance and disassembly/assembly.

### BRIEF DESCRIPTION OF THE DRAWINGS

To describe the technical solutions in the embodiments of the present disclosure more clearly, the following briefly introduces the accompanying drawings required for describing the embodiments. It should be understood that the accompanying drawings show only certain embodiments of the present disclosure and should not be considered as limiting the scope. For those of ordinary skill in the art, other related drawings can be obtained from these drawings without creative effort.

FIG. 1 is a front view of the present disclosure.

FIG. 2 is an internal structural view of the main body of the present disclosure.

FIG. 3 is a structural view of the shock absorption assembly of the present disclosure.

FIG. 4 is an exploded view of the butting assembly and the shock absorption assembly of the present disclosure.

FIG. 5 is a bottom view of the butting assembly and the shock absorption assembly of the present disclosure.

FIG. 6 is a structural view of the connection member of the present disclosure.

FIG. 7 is a partially enlarged view of FIG. 2

FIG. 8 is a structural view of a damping member.

List of Reference Numerals: 1: Main body 2: Wing 3: Inner base plate 4: Side plate 5: Connection member 50: Bracket 51: Engagement protrusion 52: Inclined portion 6: Shock absorption assembly 60: Annular upper support plate 601: Arc-shaped boss 61: Lower support plate 610: Recess 612: Connection hole 63: Damping member 630: Mating rod 64: Engaging groove 7: Butting assembly 70: Locking plate 71: Connecting rod 72: Locking spring 73: Push-pull member 74: Limiting member 75: Insertion portion 76: Electrical component 77: Protective plate.

### DETAILED DESCRIPTION OF THE EMBODIMENTS

To make the objectives, technical solutions, and advantages of the embodiments of the present disclosure clearer, the following clearly and completely describes the technical solutions in the embodiments of the present disclosure with reference to the accompanying drawings. It is evident that the described embodiments are part of the embodiments of the present disclosure, not all of them. Based on the embodiments of the present disclosure, all other embodiments obtained by those of ordinary skill in the art without creative effort fall within the scope of protection of the present disclosure. Therefore, the following detailed description of the embodiments of the present disclosure provided in the accompanying drawings is not intended to limit the scope of the claimed invention but merely represents selected embodiments of the present disclosure. Based on the embodiments of the present disclosure, all other embodiments obtained by those of ordinary skill in the art without creative effort fall within the scope of protection of the present disclosure.

In the description of the present disclosure, the terms “first” and “second” are used for descriptive purposes only and are not to be construed as indicating or implying relative importance or implicitly indicating the number of the indicated technical features. Thus, features defined with “first” and “second” may explicitly or implicitly include one or more of those features. In the description of the present disclosure, “a plurality of” means two or more, unless otherwise explicitly and specifically defined

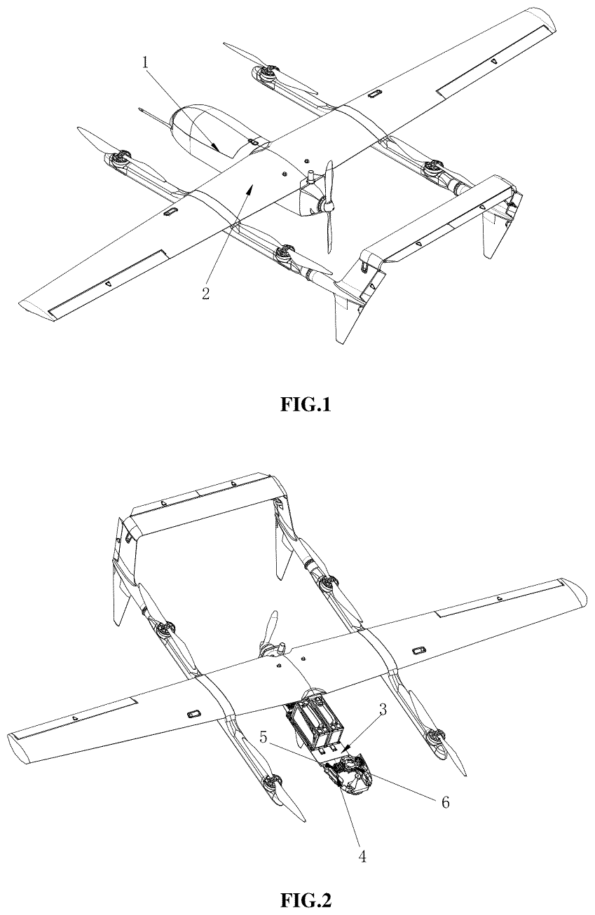

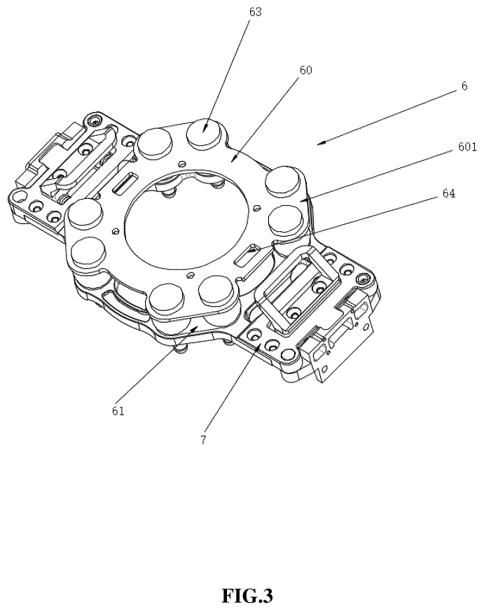

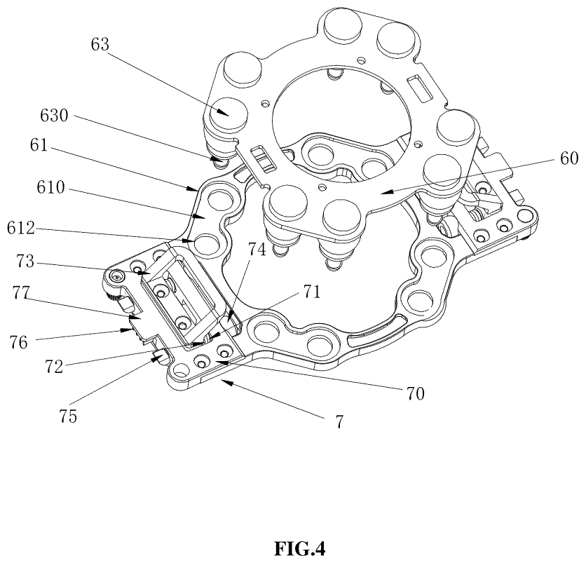

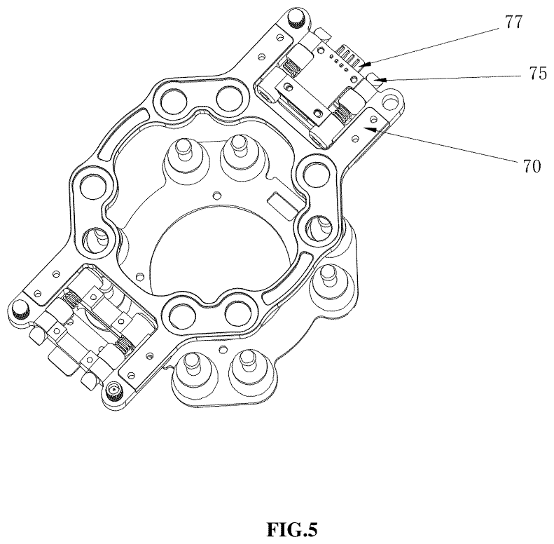

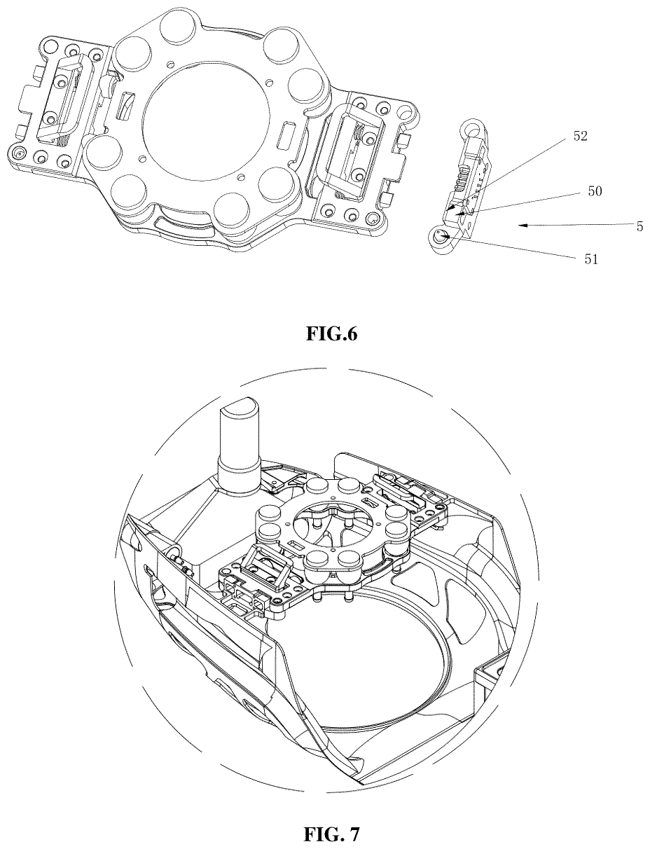

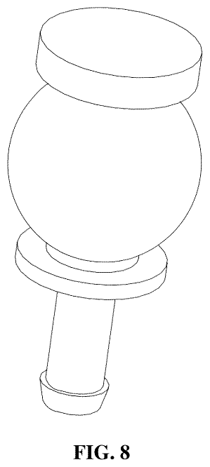

Referring to FIGS. 1-6, a UAV payload device mounting assembly with a shock absorption structure includes:
a main body 1 and wings 2 connected to the main body 1;
a side plate 4 and a connection member 5 disposed at an edge of an inner side of the side plate 4, wherein the connection member 5 includes a bracket 50, an end of the bracket 50 is provided with an engagement protrusion 51, and a front end surface of the bracket 50 forms an inclined portion 52 for sliding contact with an insertion portion 75; the inclined portion 52 has an angle D, where D is greater than or equal to 30 degrees or less than or equal to 45 degrees; in one embodiment, to allow the insertion portion 75 to slide and press-fit with the inclined portion 52 without needing to push or pull the push-pull member 73, angle D is approximately 45 degrees;
two sets of brackets 50 are arranged on the side plate 4, the engagement protrusions 51 on the two brackets 50 are designed oppositely; at the same time, the locking plate 70 is provided with another set of opposite engagement protrusions 51; during installation, this design serves as a direction fool-proof feature, preventing operator errors; and
a mounting component, composed of a shock absorption assembly 6 and a butting assembly 7 for installation of a gimbal inside the main body 1; it should be noted that the entire weight of the mounting component may be approximately 1200 g.

Specifically, the entire mounting component (gimbal) is a quick-release component, meaning the shock absorption assembly 6 and the butting assembly 7 can be quickly disassembled and assembled. This provides the benefits of rapid usage and independent storage, protecting the mounting component (gimbal).

Since most other UAVs still use screws for installation, subsequent disassembly and assembly are time-consuming and laborious, and also disadvantageous for storing the gimbal after operation completion. Furthermore, the gimbal in this disclosure is not limited; the gimbals of different types and effects can be used to accomplish required mission scenarios. Additionally, the electrical connector also has universal functionality, thus enabling the gimbal to be replaced at any time.

Compared to existing gimbals with cumbersome disassembly and complex structures, the mounting component (gimbal) of this disclosure has greater promotion value.

The shock absorption assembly 6 includes: an annular upper support plate 60, a lower support plate 61, and damping members 63. The material of the annular upper support plate 60 is carbon fiber, and the material of the lower support plate 61 is aluminum alloy. The annular upper support plate 60 has a periphery laterally protruding outward to form a plurality of arc-shaped bosses 601. The arc-shaped bosses 601 are symmetrically arranged in pairs, and the arc-shaped bosses 601 are provided with a plurality of first through holes. The lower support plate 61 is provided with recesses 610 corresponding to the arc-shaped bosses 601, and the recesses 610 are provided with a plurality of second through holes 612 corresponding to the plurality of first through holes. The damping members 63 are connected between the first through holes and the second through holes 612.

Considering that the mounting component (gimbal) described in the present disclosure is used on UAVs, weight reduction grooves or weight reduction holes can be respectively provided on the annular upper support plate 60 and the lower support plate 61 to reduce the overall weight. Of course, weight reduction circular holes 12 and weight reduction square holes 13 can be set simultaneously. The main function of the weight reduction grooves or holes is to reduce the weight of the corresponding annular upper support plate 60 and lower support plate 61. Their size, location, and quantity are not strictly required, as long as the structural strength of the annular upper support plate 60 and lower support plate 61 meets usage requirements, they can be set according to actual conditions.

A top surface of the annular upper support plate 60 is symmetrically provided with engaging grooves 64 for engaging with and clamping a camera.

Further, a thickness of the annular upper support plate 60 is 0.5-5 mm. To prevent the annular upper support plate 60 from affecting the rebound performance of the damping members 63, preferably, the thickness of the annular upper support plate 60 is about 3 mm.

Further, the recess 610 has a depth C, where C is greater than or equal to 5 mm or less than or equal to 7 mm. To ensure the damping members 63 further providing a stabilization effect, depth C is preferably about 5 mm. It should be noted that the design of the recess 610 not only provides a stabilizing effect but also offers more space for deformation, thereby enhancing shock absorption effect. When the damping members 63 are compressed, the recesses 610 can prevent the damping members 63 from being squeezed out from the hole edge. Furthermore, deformation of the damping members 63 within the recesses 610 may help reduce noise generated by vibrations. Additionally, the recesses 610 help secure the damping members 63, improving the stability of the entire mounting structure. Moreover, deformation of the damping members 63 within the recesses 610 around the holes can reduce wear or damage to the hole edge and optimize the load transfer from the damping members 63 to the mounting structure, reducing vibration transmission.

Further, the edge of the recess 610 near the inner ring edge of the lower support plate 61 is slightly higher than the edge of the recess 610 near the outer ring edge of the lower support plate 61. The benefit of this configuration is that it provides position limiting for the damping members 63, preventing excessive vertical movement or detachment of the damping members 63.

The butting assembly 7 includes: a locking plate 70; a connecting rod 71 disposed at the middle of the locking plate 70; a locking spring 72 disposed on an outer wall of the connecting rod 71; a push-pull member 73 disposed on the outer wall of the connecting rod 71 at a position forward of the locking spring 72; an insertion portion 75 disposed at a front end of the push-pull member 73; and a limiting member 74 disposed at a second end of the connecting rod 71. Pushing the push-pull member 73 compresses the locking spring 72, the insertion portion 75 connects with the connection member 5, and the locking spring 72 rebounds, fixing the mounting component on the side plate 4.

Each of the two locking plates 70 is provided with a protective plate 77 at a side located above the electrical component 76. In practice, the protective plate 77 can prevent damage to the exposed plug end of the electrical component 76. At the same time, it can also prevent foreign objects from adhering to the plug end of the electrical component 76, thereby effectively protecting the electrical component 76.

Further, the two sets of push-pull members 73 are inclined toward the center of the annular upper support plate 60. This configuration makes it more convenient for the operator to lift the entire mounting component during use, and this arrangement also makes the structure of the entire mounting component appear more compact and centralized.

An end of each damping member 63 is provided with a mating rod 630, the mating rods 630 are configured for quick positioning and installation with the connection holes 612 provided inside the recesses 610.

Further, the shape of the damping member 63 is gourd-shaped, square, or rectangular. To ensure the annular upper support plate 60 provides good buffering for the gimbal, the damping member 63 is preferably gourd-shaped. Further, a circular portion of the gourd-shaped damping member 63 is embedded into the connection hole 612, accurately positioning the damping member 63 at the designated location, providing better stability and reducing rotation or movement of the damping member 63 within the hole. Moreover, the circular portion of the gourd-shaped damping member 63 can self-adapt to different loads and contact surface shapes, providing more uniform pressure distribution. Simultaneously, the circular portion provides a larger surface area to absorb and disperse vibrations, potentially offering better shock absorption than square rubber pads.

As shown in FIG. 8, the damping member includes a top plate, a spherical member disposed below the top plate, the mating rod connected to the bottom of the spherical member and a support ring disposed around the mating rod and in a distance from the bottom of the spherical member. When being installed in place, the top plate is located on an upper surface the annular upper support plate 60, the support ring is located on a bottom surface of the lower support plate 61, and the spherical member supports between the annular upper support plate 60 and the lower support plate 61.

As a more specific implementation, the damping member 63 may also be a damping ball. The damping member 63 is preferably made of rubber but is not limited to rubber, it may also be made of other materials with appropriate elasticity. In addition, in this embodiment, the number of damping members 63 is not specifically limited, as long as they can provide sufficient elasticity for the mounting component (gimbal) to ensure the stability during UAV flight. Preferably, damping members 63 are arranged in groups at least at the arc-shaped bosses 601 at four corners.

Further, a hollowed-out hole in the middle of the annular upper support plate 60 and a hole in the middle of the lower support plate 61 have different shapes, meaning different space sizes. The benefits of this design are: (1) it can provide sufficient movement space for the camera, avoiding friction between the camera and the lower support plate 61 or annular upper support plate 60 during movement; (2) more space allows for adjusting the camera position to suit different shooting requirements; (3) the larger hole size in the lower support plate 61 provides more space for heat dissipation, helping maintain a suitable temperature for the camera during prolonged use; (4) the larger slot space may facilitate cable arrangement and management, avoiding messy wiring and reducing the risk of wire snagging; (5) the larger hole size in the lower support plate 61 can provide additional buffer space between the camera and the arc-shaped bosses 601, helping absorb vibrations and reduce impact on the camera; (6) the larger hole size in the lower support plate 61 may allow for the integration of other components, such as sensors, displays, or control buttons.

Therefore, during design, the camera needs to be installed in a suitable position, while also considering the practical application of the camera.

Further, the design of the arc-shaped bosses 601 increases the surface area of the annular upper support plate 60, providing a larger support area for the damping members 63, thereby improving its stability. At the same time, it helps distribute the load more evenly, reducing local stress concentration on the damping rubber. Furthermore, it also increases the stiffness of the overall structure, providing more stable support for the damping member 63.

Specifically, a thickness of the arc-shaped boss 601 is 1.5 mm-3 mm. To enable the arc-shaped boss 601 to disperse stress more effectively, the thickness is preferably about 2 mm.

Further, since the camera and gimbal (structures including annular upper support plate 60, etc.) will experience vibrations during UAV operation, the vibration source generated by the gimbal directly corresponds to the impact source connection area in the middle of the annular upper support plate 60. Moreover, since the impact source connection area is directly subjected to the impact of compression waves (longitudinal waves), which propagate quickly and have small amplitude, they are difficult to absorb rapidly. If damping members 63 were only arranged at this location, at least twice the number of damping members 63 would be needed to achieve the same effect, at a significant weight cost. However, after passing through the arc-shaped bosses 601, most compression waves (longitudinal waves) are converted into shear waves (transverse waves). Due to the slower propagation speed and larger amplitude of shear waves, arranging the arc-shaped bosses 601 with damping members 63 on the periphery of the annular upper support plate 60 can efficiently dissipate the impact energy of the shear waves (transverse waves), significantly improving impact resistance. Thus, it can also greatly reduce the overall weight and volume of the mounting assembly. Consequently, when vibrations occur in the annular upper support plate 60, the coordinated use of the damping members 63 and structures like the annular upper support plate 60 can greatly reduce camera vibration, improving camera utility.

A bottom of the locking plate 70, between the two connecting rods 71, is provided with an electrical component 76, which plugs into a power interface on the bracket 50 to control power on/off to the gimbal.

Here, the locking plate 70 and the electrical component 76 are combined to form a new type of switch mounting component. In practical use, when this switch mounting component connects to the power interface on the bracket 50, the camera device mounted on the mounting component (gimbal) is powered. Compared to the original method using multiple power cables, this structure is more convenient, simultaneously reducing the number of wiring harnesses. Moreover, the wiring harnesses can be hidden inside the side plate 4, and the side plate 4 is hollow inside, thus concealing the wiring harness. This ensures that during camera operation, the wiring harnesses do not interfere with the camera's movement.

The above descriptions are merely preferred embodiments of the present disclosure and are not intended to limit the present disclosure. For those skilled in the art, the present disclosure may have various modifications and changes. Any modification, equivalent replacement, or improvement made within the spirit and principles of the present disclosure shall be included within the scope of protection of the present disclosure.

What is claimed is:

1. An Unmanned Aerial Vehicle (UAV) payload device mounting assembly with a shock absorption structure, comprising:
a main body and wings connected to the main body;
a side plate and a connection member disposed at an edge of an inner side of the side plate;
a mounting component, composed of a shock absorption assembly and a butting assembly, for mounting a gimbal inside the main body;
wherein the shock absorption assembly comprises: an annular upper support plate, a lower support plate, and damping members; a periphery of the annular upper support plate forms a plurality of arc-shaped bosses laterally protruding outward, the arc-shaped bosses being symmetrically arranged in pairs, and the arc-shaped bosses are provided with a plurality of first through holes; the lower support plate is provided with recesses corresponding to the arc-shaped bosses, the recesses are provided with second through holes corresponding to the plurality of first through holes; the damping members are connected between the first through holes and the second through holes.

2. The Unmanned Aerial Vehicle (UAV) payload device mounting assembly with a shock absorption structure according to claim 1, wherein the connection member comprises a bracket, the bracket is provided at an end with an engagement protrusion, and a front end surface of the bracket forms an inclined portion for sliding contact with an insertion portion.

3. The Unmanned Aerial Vehicle (UAV) payload device mounting assembly with a shock absorption structure according to claim 2, wherein the inclined portion has an angle D, and the angle D is greater than or equal to 30 degrees or less than or equal to 45 degrees.

4. The Unmanned Aerial Vehicle (UAV) payload device mounting assembly with a shock absorption structure according to claim 1, wherein damping members is each provided at an end with a mating rod, the mating rods are configured for quick positioning and installation with the second through holes provided inside the recesses.

5. The Unmanned Aerial Vehicle (UAV) payload device mounting assembly with a shock absorption structure according to claim 1, wherein each of the recesses has a depth C, wherein the depth C is greater than or equal to 5 mm or less than or equal to 7 mm.

6. The Unmanned Aerial Vehicle (UAV) payload device mounting assembly with a shock absorption structure according to claim 1 further comprising a butting assembly, wherein the butting assembly comprises: a locking plate; a connecting rod disposed at a middle portion of the locking plate; a locking spring disposed on an outer wall of the connecting rod; a push-pull member disposed on the outer wall of the connecting rod at a position forward of the locking spring; the insertion portion disposed at a front end of the push-pull member; and a limiting member disposed at a second end of the connecting rod; wherein pushing the push-pull member compresses the locking spring, the insertion portion connects with the connection member, and the locking spring rebounds, fixing the mounting component on the side plate.

7. The Unmanned Aerial Vehicle (UAV) payload device mounting assembly with a shock absorption structure according to claim 6, wherein a bottom of the locking plate, between two of the connecting rods, is provided with an electrical component, the electrical component plugs into a power interface on the bracket to control power on/off to the gimbal; and two locking plates are assembled with a side above the electrical component being provided with a protective plate.

8. The Unmanned Aerial Vehicle (UAV) payload device mounting assembly with a shock absorption structure according to claim 1, wherein the arc-shaped bosses are arranged circumferentially around the annular upper support plate with equal space apart from each other.

9. The Unmanned Aerial Vehicle (UAV) payload device mounting assembly with a shock absorption structure according to claim 1, wherein a top surface of the annular upper support plate is symmetrically provided with engaging grooves for engaging with and clamping a camera.

10. The Unmanned Aerial Vehicle (UAV) payload device mounting assembly with a shock absorption structure according to claim 1, wherein a material of the annular upper support plate is carbon fiber, and a material of the lower support plate is aluminum alloy.
